(19) United States
(12) Patent Application Publication
(10) Pub. No.: US 2019/0041588 A1
(43) Pub. Date: Feb. 7, 2019

(54) FIELD INSTALLABLE OPTICAL FIBER CONNECTOR FOR FIBER OPTIC CABLES WITH RIGID STRENGTH MEMBERS

(71) Applicant: Corning Research & Development Corporation, Coming, NY (US)

(72) Inventors: Christine B. Bund, Neuss (DE); Johann G. Hajok, Neuss (DE)

(21) Appl. No.: 16/157,717

(22) Filed: Oct. 11, 2018

Related U.S. Application Data
(63) Continuation of application No. PCT/IB2017/051895, filed on Apr. 3, 2017.
(60) Provisional application No. 62/321,413, filed on Apr. 12, 2016.

(51) Int. Cl. G02B 6/38

(52) U.S. Cl. CPC G02B 6/3869; G02B 6/3846; G02B 6/3887

(57) ABSTRACT

The present invention is directed to a field installable optical fiber connector for fibers optic cables with rigid strength members. In particular, the exemplary optical fiber connector includes a clamping member disposed within the connector that engages with and secures the rigid strength members of the optical fiber drop cable.

### CROSS-REFERENCE TO RELATED APPLICATIONS

This application is a continuation under 35 U.S.C. § 111(a) of International Application No. PCT/M2017/051895 filed on Apr. 3, 2017, and claims the benefit of U.S. Provisional Patent Application No. 62/321,413 filed on Apr. 12, 2016, wherein the disclosures of the foregoing applications are hereby incorporated by reference herein in their entireties.

### TECHNICAL FIELD

The present invention is directed to a field installable optical fiber connector for fiber optic cables with rigid strength members. In particular, the exemplary optical fiber connector includes a clamping member that is configured to engage with and secure the rigid strength members of the optical fiber drop cable.

### BACKGROUND

The present invention is directed to an optical fiber connector and method for terminating a jacketed optical fiber drop cable in the field. In particular, the exemplary connector includes a backbone that retains a collar body within an outer housing, wherein the backbone includes at least one guide channel to facilitate wrapping strength members of an optical fiber drop cable around a rear portion of the backbone and a cable jacket clamping portion to clamp a cable jacket that surrounds a portion of the optical fiber.

### RELATED ART

Mechanical optical fiber connectors for the telecommunications industry are known. For example, LC, ST, FC, and SC optical connectors are widely used. However, commercially available optical fiber connectors are not well suited for field installations. Typically, an adhesive is required to mount these types of connectors on to an optical fiber. This process can be awkward and time consuming to perform in the field. Also post-assembly polishing requires that the craftsman have a higher degree skill.

Also known are hybrid optical fiber splice connectors, as described in JP Patent No. 3445479, JP Application No. 2004-210251 (U.S. Pat. No. 7,637,673) and JP Application No. 2004-210357 (U.S. Pat. No. 7,556,438). However, these hybrid splice connectors are not compatible with standard connector formats and require significant piecewise assembly of the connector in the field. The handling and orientation of multiple small pieces of the connector can result in incorrect connector assembly that may either result in decreased performance or increase the chance of damaging the fiber.

More recently, U.S. Pat. No. 7,369,738 describes an optical fiber connector that includes a pre-polished fiber stub disposed in ferrule that is spliced to a field fiber with a mechanical splice. Aramid strength members found in some optical fiber drop cables can be captured between the boot and the connector body to provide a connector termination capable of surviving rougher handling and greater pull forces. Such a connector, called a 3M™ No Polish Connector (also referred to as an NPC), is now commercially available through 3M Company (St. Paul, Minn.).

However, many optical fiber drop cables include rigid strength rods which cannot be secured in conventional optical fiber connectors. Today, these rigid rods are simply cut away so that they do not interfere with the termination of said drop cables with conventional optical fiber connectors. Thus, there is a need for an optical fiber connector that is capable of engaging with these rigid rod strength members.

### SUMMARY

According to a first embodiment of the present invention, an optical fiber connector is described for terminating a jacketed optical fiber drop cable with rigid strength members. The optical fiber connector includes a housing configured to mate with a receptacle, a backbone to retain the collar body within the housing and a clamping member to engage with the rigid strength members of the optical fiber drop cable. The collar body has a ferrule mounted in the first end and a mechanical element disposed within a portion of the collar body, and the backbone including a fiber guide channel between a pair of arms. The clamping member is disposed within the fiber guide channel to secure the rigid strength members within the backbone of the connector. The connector further includes a boot that attaches to a portion of the backbone, wherein the boot actuates the cable jacket clamping portion of the backbone upon attachment to the backbone.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIGS. 1 A and IB are two views an optical fiber connector according to an embodiment of the present invention.

FIGS. 2A and 2B are two views a clamping member of the optical fiber connector of Figs.

FIGS. 3A and 3B show how the exemplary clamping member can be assembled into a backbone of the optical fiber connector of FIGS. 1A-1B.

FIG. 4 shows the insertion of a prepared optical fiber drop cable with rigid strength members being inserted into the backbone of the exemplary optical fiber connector according to an embodiment of the present invention.

FIGS. 5 A and 5B show how the exemplary clamping member grips the rigid strength members during and after installation of the optical fiber connector according to an embodiment of the present invention.

FIG. 6 shows an exemplary optical fiber connector mounted on the end of an optical fiber drop cable with rigid strength members according to an embodiment of the present invention.

FIGS. 7A-7C show three detail views of the optical fiber connector defined by FIG. 6.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention.

The present invention is directed to an optical fiber connector and method of field termination of a jacketed optical fiber drop cable with rigid strength members. In particular, the optical fiber connector of the exemplary embodiments is of compact length and is capable of straightforward field termination. The exemplary connector(s) described herein can be readily installed and utilized for Fiber to the Home (FTTH) and/or Fiber to the X (FTTX) network installations. The exemplary connector(s) can be utilized in installation environments that require ease of use when handling multiple connections, especially where labor costs are more expensive. In addition, the exemplary connectors, described herein, provide higher pull out forces than other conventional field mount connectors, especially for outdoor jacketed drop cables with rigid strength members.

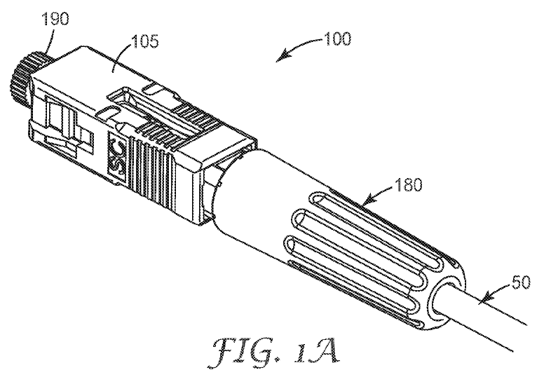

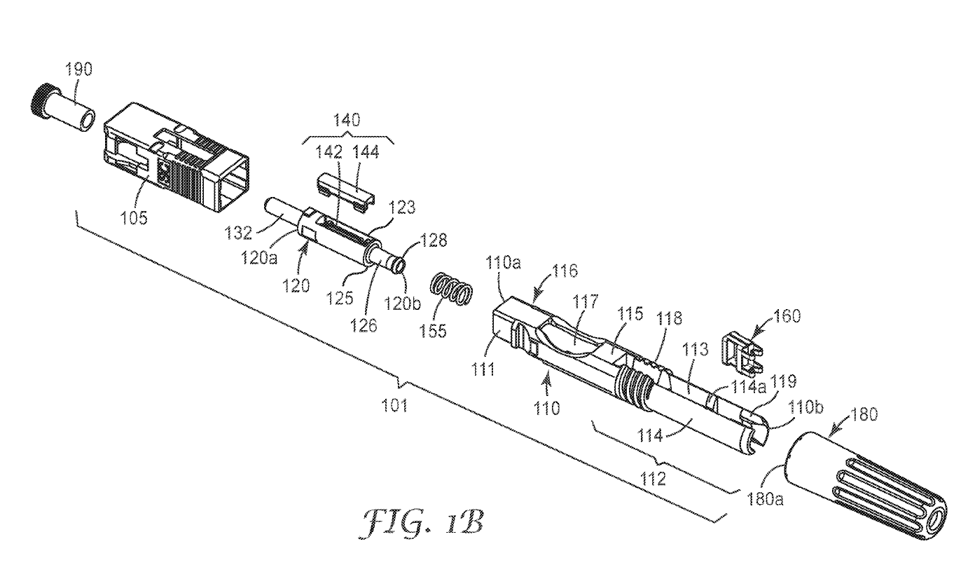

According to an exemplary embodiment of the present invention, an optical fiber connector 100 is shown in isometric assembled view in FIG. 1 A and an isometric exploded view in FIG. 1B. Optical connector 100 is configured to mate with a receptacle of a corresponding format. For example, as shown in FIG. 1, exemplary optical connector 100 is configured as having an SC format. However, as would be apparent to one of ordinary skill in the art given the present description, optical connectors having other standard formats, such as ST, FC, and LC connector formats, can also be provided.

As shown in FIG. 1, SC-type optical fiber connector 100 can include a connector body 101 having an outer housing 105 and a boot 180 attached to the second end of the connector body. In particular, the outer housing of the exemplary connector can have an SC-format that is configured to mate with an SC-format connector adapter (not shown). A dust cap 190 can be placed at the first end of the connector to protect the end of the ferrule and the optical fiber disposed therein when the connector is not in use. In one exemplary aspect, the optical fiber disposed in the ferrule can be an optical fiber stub that is adhesively secured within the ferrule. In an alternative aspect, the optical fiber disposed in the ferrule can be a field fiber from an optical fiber drop cable that has been terminated by the exemplary connector.

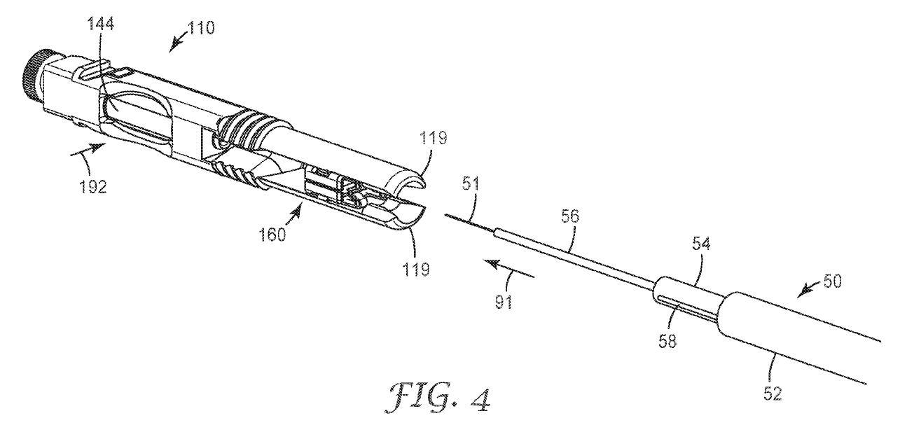

In one exemplary embodiment, connector 100 can be utilized to terminate an optical fiber drop cable 50 (see e.g., FIGS. 1A and 4). Optical fiber drop cable 50 is a jacketed optical fiber drop cable that includes a fiber portion 51 (e.g., the bare clad/core), a coated portion 56 disposed on the fiber portion, a buffer layer 54 disposed over the coated portion, a pair of rigid strength members 58, and a cable jacket 52 disposed around and protecting all of the internal layers of the optical fiber drop cable. In a preferred aspect, the rigid strength members 58 comprise either rigid glass reinforced polymer (GRP) rods or rigid fiber reinforced polymer (FRP) rods disposed between the buffer layer and the cable jacket of the exemplary optical fiber drop cable. In some aspects, the FRP or GRP rods can have a soft exterior plastic or polymer coating. Optical fiber drop cable 50 can have a standard cylindrically shaped cable structure or it can be an alternatively shaped structure, such as a rectangular-shaped cable structure or an oval or elliptical shaped cable structure. In an exemplary aspect, the optical fiber drop cable 50 is a standard optical fiber drop cable having a 250μπι coated portion, a 900μπι buffer layer and a cable jacket 52 having an outer diameter of from about 1.6 mm to about 5 mm. In one exemplary aspect, the optical fiber drop cable can be a round simplex drop cable with rigid strength members, such as an ACOPTIC®—FTTH U B 1629—Outside branch cable available from Acome (Paris, France) or FTTH Indoor/Outdoor Drop cables available from Prysmian Group (Milan, Italy). In another aspect, the optical fiber drop cable can be drop cables having an elongated cross-section such as a ROC™ Drop Dielectric, Gel-Free Cable 1 F, Single-mode (OS2) available from Corning Cable Systems LLC (Hickory, N.C.), a CAS FLAT/Fl—Flat Drop Cable available from OPTRAL (Madrid, Spain) or an FRP cable from 3M Company (ST. Paul, Minn.). Of course, in alternative aspects, the optical fiber connector can be adapted to accommodate fiber cables of different dimensions, as would be apparent to one of skill in the art given the present description.

Optical fiber connector 100 includes a connector body 101 comprising a collar body 120 (which can also be referred to as a barrel) to house a ferrule and a splice device, a multi-purpose backbone 110 that retains the collar body 120 within the connector, and outer housing 105, a clamping member 160 that is configured to engage with the rigid strength members on an optical fiber drop cable when it is disposed in a rear portion of the backbone and a boot 180.

Collar body 120 (best seen in FIG. 1B) is disposed within the connector housing and retained by the backbone in the assembled connector shown in FIG. 1 A. According to exemplary embodiments, the collar body 120 is a multi-purpose element that holds a ferrule 132 in an opening (not shown) in a first end of the collar body and a mechanical element 142 in an element housing portion 123. Element housing portion 123 provides an opening in which a mechanical element 142 can be inserted and secured in the central cavity of collar body 120. In an exemplary embodiment, mechanical element 142 is part of a mechanical holding device 140 (also referred to herein as a mechanical splice device or gripping device).

In an exemplary aspect, the mechanical element can be similar to the mechanical element used in a mechanical splice such as a 3M™ FIBRLOK™ mechanical fiber optic splice device or a 3M™ FIBRLOK™ 4×4 mechanical fiber optic splice device, available from 3M Company, of Saint Paul, Minn., which is described in commonly owned U.S. Pat. No. 5,159,653, incorporated herein by reference in its entirety. An optical fiber splice device (similar to a 3M™ FIBRLOK™ II mechanical fiber optic splice device) is described therein that includes a splice element that comprises a sheet of ductile material having a focus hinge that couples two legs, where each of the legs includes a fiber gripping channel (e.g., a V-type (or similar) groove) to optimize clamping forces for conventional glass optical fibers received therein. The ductile material, for example, can be aluminum or anodized aluminum. In addition, a conventional index matching fluid can be preloaded into the V-groove region of the splice element for improved optical connectivity within the splice element. In another aspect, no index matching fluid is utilized. Other conventional mechanical splice devices can also be utilized in accordance with alternative aspects of the present invention and are described in U.S. Pat. Nos. 4,824,197; 5,102,212; 5,170,787; and 7,135,787, each of which is incorporated by reference herein, in their entirety.

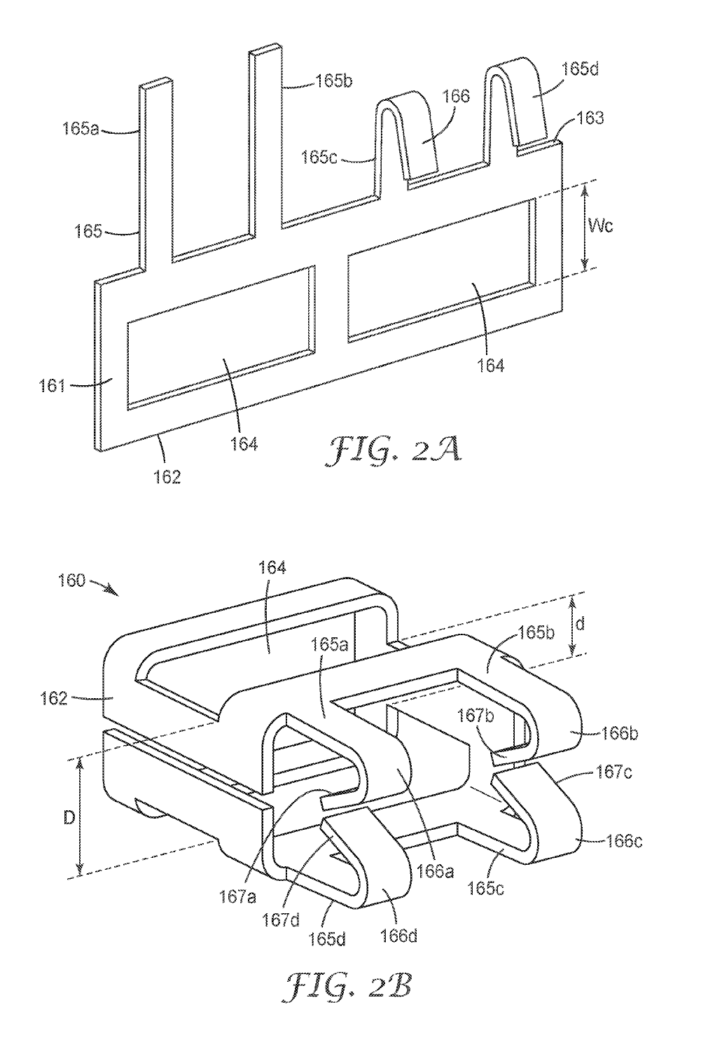

Mechanical element 142 of mechanical holding device 140 allows a technician to install connector 100 on the prepared end of an optical fiber drop cable at a field installation location. In an exemplary embodiment mechanical holding device 140 includes a mechanical element 142 and an actuating cap 144 (FIG. 2B). In operation, as the cap 144 is moved from an open position to a closed position, one or more cam bars located on an interior portion of the cap can slide over the mechanical element legs, urging them toward one another to complete secure the fiber(s) within the collar body 120.

The collar body can be configured to have some limited axial movement when disposed within backbone 140. For example, the collar body 120 can include a collar or shoulder 125 that can be used as a flange to provide resistance against spring 155 (see FIG. 1B), disposed over end portion 126 of the collar body.

The collar body also includes a second end portion 126 configured to engage with the collar body mount structure 115 of backbone 110. In a preferred aspect, second end portion 126 has a raised end structure 128 that has a sloping shape that is insertable through a bore of the collar body mount structure, as is shown in FIG. 1B. Raised end structure 128 of the second end portion can be inserted into the bore and engage against collar body mount structure 115 due to the bias of the spring 155 which is disposed between the shoulder 125 of the collar body and the backbone's mounting structure as shown in FIG. 1B.

Ferrule 132 can be formed from a ceramic, glass, plastic, or metal material to support the optical fiber stub or optical fiber disposed therein. In a preferred aspect, ferrule 132 is a ceramic ferrule.

In a first embodiment, optical fiber connector 100 can be a remote grip fiber connector such that the end of the bare glass portion of the field fiber of the optical fiber stub cable extends through to the front face of the ferrule. In this embodiment, the mechanical element is a mechanical gripping device configured to secure the bard glad portion of the field fiber within the connector.

In a second embodiment, collar body 120 can optionally include a stub fiber pre-assembled in the connector ferrule 132 if the optical fiber connector 100 is a stub fiber connector. In addition, if optical fiber connector 100 is a stub fiber connector, mechanical element 142 will be a mechanical splice device configured to interconnect the bare glass portion of the field fiber from the optical fiber drop cable with the stub fiber disposed within the collar body. The stub fiber can be a short piece of standard single mode or multimode optical fiber, such as SMF 28 (available from Corning Inc.), inserted through ferrule 132, such that a first fiber stub end slightly protrudes from or is coincident or coplanar with the end face of ferrule 132 and secured in place (e.g., by epoxy or other adhesive). Preferably, the first fiber stub end is factory polished (e.g., a flat or angle-polish, with or without bevels). A second end of the fiber stub (not shown) extends part-way into the interior of the connector 100 and is spliced to the bare glass portion of the field fiber in the mechanical splice device. Preferably, the second end of fiber stub is cleaved (flat or angled, with or without bevels). In an alternative aspect, the second end of fiber stub can be polished in the factory to reduce the sharpness of the edge of the fiber, which can create scrapings (debris) as it is installed in the splice element. For example, an electrical arc, such as one provided by a conventional fusion splicer machine, can be utilized to melt the tip of the fiber and form a rounded end, thereby removing the sharp edges. This electrical arc technique can be used in conjunction with polishing by an abrasive material to better control end face shape while reducing possible distortion of the core. An alternative non-contact method utilizes laser energy to ablate/melt the tip of the fiber.

Backbone 110 (see e.g., FIGS. 1B, 3A-3B, 4 and 5A-5B) provides structural support for the connector 100. The backbone is an elongated hollow structure extending from a front end 110a to a back end 110b that provides axial strain relief by securing the rigid strength members of the optical fiber drop cable. The back bone can further provide added strain relief by clamping onto to the jacket or buffer layer of the optical fiber drop cable.

Backbone 110 includes a hollow front portion 111 configured to receive the connector collar body 120. The backbone includes an opening (not shown) at a front end 110a to allow for insertion of the collar body 120 into the hollow front portion of the backbone. Backbone 110 further includes an access opening 117 through a side wall of the front portion of the backbone, which provides access to actuate a mechanical splice device disposed within the connector collar body that is secured within the front portion of the backbone. In a preferred aspect, access opening 117 can have a cut-out or shallow depression formed on the sides to accommodate a user's thumb or finger during actuation of the splice device. The backbone 110 has an axial bore throughout to permit passage of the optical fiber being terminated.

The rear portion 112 of backbone 110 comprises a collet-type, split body shape having two collet legs 114 at the second end of the backbone. The backbone 111 can further include a mounting structure 118 that provides for coupling to the fiber boot 180. In an exemplary aspect, the mounting structure comprises a threaded surface formed on an outer portion of backbone that is configured to engage corresponding threaded grooves disposed inside of the first end 180a of the boot 180.

The backbone 110 includes a collar body mount structure 115 configured to receive and secure the collar body 120 within the backbone. In a preferred aspect, collar body mount structure 115 comprises a rigid structure formed in an interior region of backbone 110 having an axial bore therethrough. The axial bore can be of appropriate size to receive and engage raised end structure 128 of collar body 120 (see FIG. 1B). In addition, collar body mount structure 115 also forms a shoulder within the backbone that can be used as a flange to provide resistance against spring 155 that is positioned over the second end portion 126 of the collar body 120. The spring provides and maintains an adequate contact force when two connectors are joined together in a connector adapter (not shown).

Backbone 110 includes a fiber guide 113 formed in the interior of rear portion 112 therein to provide axial alignment support for the optical fiber cable being terminated. Fiber guide 113 can include a funnel-shaped channel adjacent to collar body mount structure 115 that aligns a coated portion of the optical fiber drop cable and guides the bare glass portion of the field fiber toward the mechanical element 142 housed in the collar body 120. In addition, fiber guide 113 includes one or more stops 114a formed on an interior portion thereof to provide a boundary for the insertion of the rigid strength members 58 of the optical fiber drop cable 50 being terminated.

In an exemplary aspect, clamping device 160 can be inserted into the fiber guide portion of backbone 110 between the one or more stops 114a (as explained in more detail below).

Backbone 110 further includes a jacket clamping portion 119 at a back end 110b of the backbone that is configured to clamp onto the cable jacket 52 of the optical fiber drop cable 50 being terminated in connector 100. In one aspect, jacket clamping portion 119 comprises a collet-type, split body shape that is actuated when the boot 180 is secured to mounting structure 118 of the backbone. The jacket clamping portion can include raised inner surfaces (i.e. ridges, barbs, or teeth) to permit ready clamping of the cable jacket 52. In an exemplary aspect, the raised inner surfaces of the jacket clamping portion can be angled so that they will bite in making it harder to pull the drop cable out of the exemplary connector. In addition, the jacket clamping portion 119 can provide a guide structure when inserting prepared end of the optical fiber drop cable 50 into the connector during the termination process. The actuation of the jacket clamping portion can provide additional retention strength over the retention strength provided by the engagement of the rigid strength members by clamping member 160.

According to an exemplary embodiment of the present invention, housing 105, collar body 120, backbone 110 and boot 180 are formed or molded from a polymer material, although metal and other suitably rigid materials can also be utilized. For example, one exemplary material can comprise a fiberglass reinforced polyphenylene sulfide resin or a polyether imide resin, such as an ULTEM material (available from SABIC). In one aspect, the materials used to form the boot 180 and the backbone 110 are the same.

Clamping member 160 can have a body portion 162 and a plurality of integrally formed fingers 165 extending from one edge 162 of the body portion. The body portion can have a hollow cage-like structure to allow a portion the drop cable being terminated by an optical fiber connector utilizing clamping member to pass through the body portion. The distal ends of the integrally formed fingers can have a hook portion 166. The hook portion 166 can include a cantilevered portion 167 that can be disposed at an angle of between about 100° to about 170°, for example, preferably about 170°, relative to the body portion at the base of the integrally formed finger. The cantilevered portions of the integrally formed fingers will face toward the interior of the clamping member (i.e. into the hollow through which a portion of the drop cable will pass). The integrally formed fingers can be arranged in facing pairs, such that the cantilevered portions of two integrally formed fingers disposed on opposite sides of the body portion extend toward one another. In an exemplary aspect, the exemplary clamping member can have a plurality of facing pairs of integrally formed fingers. For example clamping member 160 has two pairs of integrally formed facing fingers. The cantilevered portions of each pair of integrally formed facing fingers will grab onto wither side of rigid strength members 58 in optical fiber drop cable 50.

The body portion 162 of clamping member 160 can include cutout portions 164 that can control the axial movement of the clamping member when the clamping member is assembled into the exemplary connector.

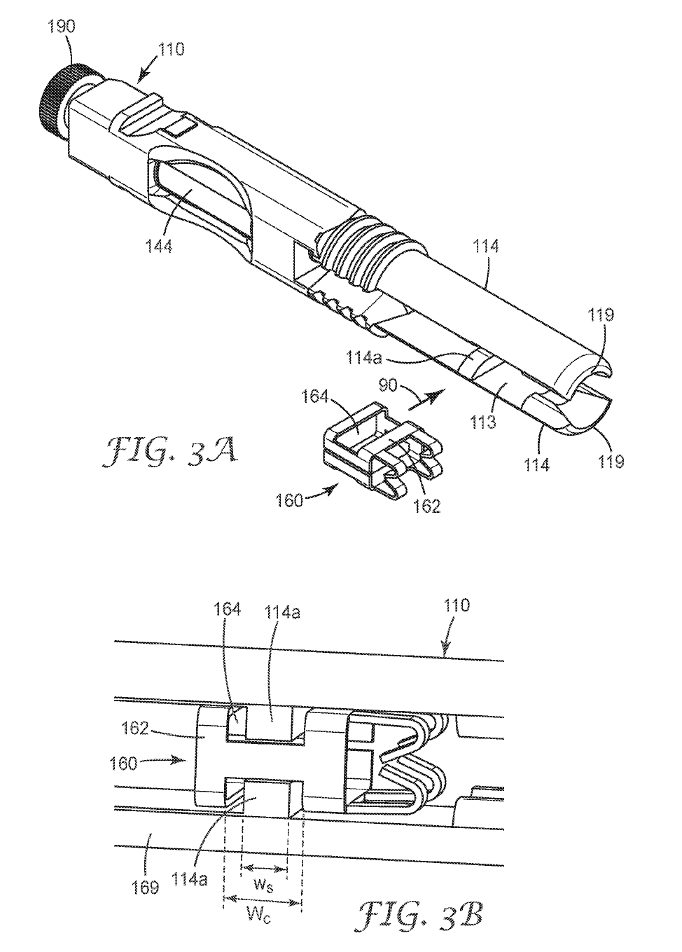

FIG. 3A shows the insertion of clamping member 160 into the fiber guide 113 formed in of rear portion 112 of backbone 110 as shown by directional arrow 90. FIG. 3B is a detail view of clamping member 160 disposed in backbone 110. The clamping member is placed so that the stops 114a are disposed in the cutout portions 164 of body portion 162 of the clamping member. The width of the stops, wₛ is slightly less than the width of the cut out portion, Wc (i.e., wₛ<W_{c}). In one aspect, width of the stops, wₛ, is sufficiently less than the width of the cut out portion, Wc so that there can be a gap 169 between an edge of the cutout portion such that the gap width, w_{g}, plus width of the stops, wₛ is approximately the same as the width of cut out portion, Wc (i.e., ws+w_{g}≤Wc). The gap between the stop and the edges of the cutout portion of the clamping member allow the clamping member to move with respect to the backbone of the optical fiber connector. The width of the gap controls the amount of movement between the clamping member and the backbone.

In one aspect, the gap 169 between the edge of the cutout portion 164 of the clamping member 160 and the stops 114a in backbone 110 control the size of the fiber bow that is created during installation. The gap then allows the clamping member to move back in the backbone after activation of the mechanical element.

Clamping member 160 can be formed from a stamped metal part 161 that can be bent to form the clamping member as shown in FIGS. 1B, 2A and 2B. FIG. 2B shows formed clamping member 160, while FIG. 2 A shows the partially formed stamped metal part. Stamped part 161 can have a body portion 162 and a plurality of integrally formed fingers 165 extending from one edge 163 of the body portion. In one exemplary aspect, the stamped part can include four integral fingers 165a-165d extending from edge 163 of the body portion. The body portion can include cutout portions 164 that can control the axial movement of the clamping member when it is assembled into the exemplary connector. In an alternative aspect, the clamping member can be fully formed injection molded plastic part.

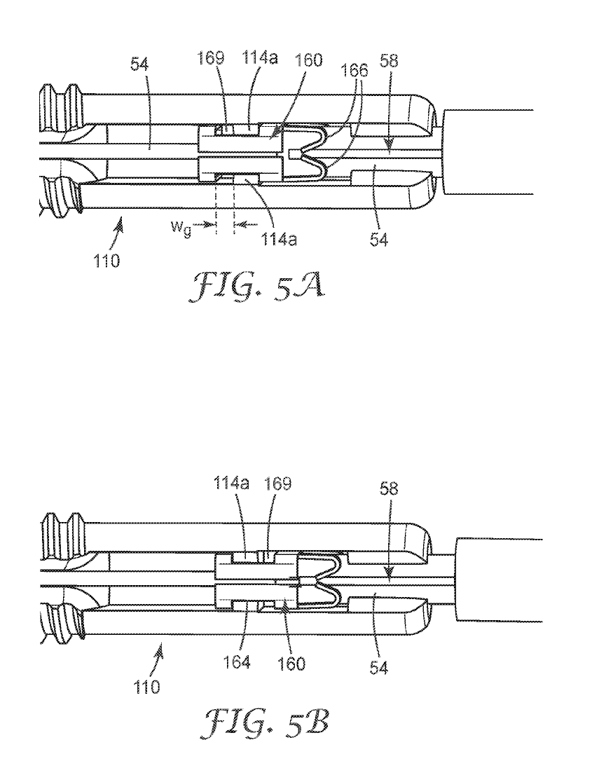

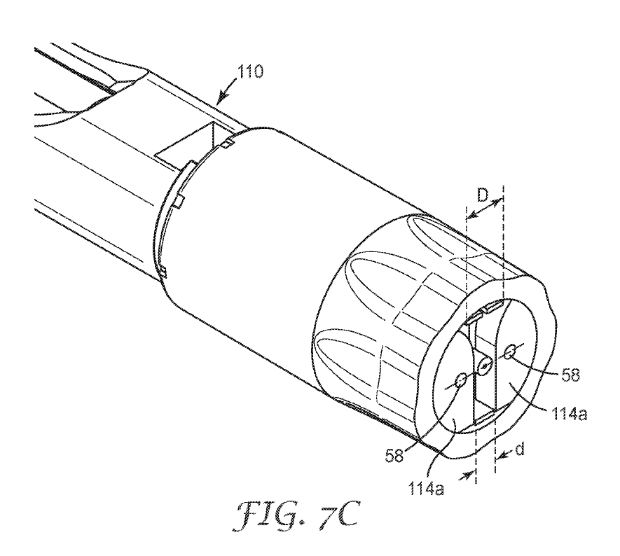

Integrally formed fingers 165 can be bent so that the distal end forms a hook portion 166. In an exemplary aspect, the hook portion 166 include a cantilevered portion 167 that can be disposed at an angle of between about 100° to about 170°, for example, preferably about 170°, relative to the body portion at the base of the finger. The next step in forming clamping member 160 is to bend the body portion 161 into a cage-like structure as shown in FIG. 2A such that the cantilevered portions 167a-167d of the hook portions 166a-166d of integrally formed fingers 165a-165d face each other. The cantilevered portions two sets of hooked fingers will grab onto the rigid strength members 58 in optical fiber drop cable 50 as will be discussed in more detail with respect to FIGS. 5A-5B and 7A-7C. In an alternative aspect, the cantilevered portions two sets of hooked fingers will grab onto the soft exterior plastic or polymer coating of coated FRP or GRP strength member rods. In yet another aspect, the cantilevered portions two sets of hooked fingers can bite into the jacket of a drop cable if it does not have rigid strength members.

Clamping member 160 can exert a holding force on the rigid strength member to facilitate handling of the connector during the termination process. Securing the boot onto the backbone can squeeze the integral fingers of the clamping member to increase the retention strength of the cable by the connector. In one aspect the final retention strength of the connector is greater than the holding force exerted on the rigid strength member before the boot is applied. As mentioned earlier, the actuation of the jacket clamping portion of the connector can further increase the retention strength of the connector.

Advantageously, the optical fiber connector of the exemplary embodiments is of compact length and is capable of straightforward field termination. As discussed above, the optical fiber connector is partly assembled by inserting the collar body 120, with ferrule 132 secured therein, within backbone 110. As mentioned above, the raised end structure 128 of the collar body is inserted into the bore of collar body mount structure 115 as shown in FIG. 1B. The spring 155 is placed over the second portion of the collar body prior to installation in the backbone and will provide some bias against axial movement after insertion.

For field termination, an optical fiber drop cable, such as drop cable 50, is prepared by stripping off a portion of the cable jacket 52 at the terminal end of the drop cable, leaving the remaining buffer layer 54, coated portion 56, fiber portion, and strength members 58 intact. For the exemplary SC-type fiber stub connector shown in the figures, this portion of the cable jacket can be about 65 mm or so. The rigid strength members 58 can be trimmed so that they extend about 12 mm to about 15 mm from the end of the cable jacket. Next, a portion of the buffer layer 54 is removed from the terminal end of the cable leaving between about 25 mm and about 40 mm of the buffer layer 54 extending from the edge of the cable jacket leaving the coated portion 56. The terminal end of the fiber is further prepared by stripping off a portion of the coated portion 56 near the terminating fiber end to reveal a bare fiber portion of the optical fiber cable. The exposed bare fiber portion can be cleaned to remove any remaining residue. The terminal end of the bare fiber portion can be cleaved (flat or angled) to match the orientation of the pre-installed fiber stub disposed within the exemplary connector. In an exemplary aspect, about 8 mm-15 mm of bare fiber portion remains. For example, a commercial fiber cleaver such as an Ilsintech MAX CI-01 or the Ilsintech MAX CI-08, available from Ilsintech, Korea (not shown) can be utilized to provide a flat or an angled cleave. No polishing of the fiber end is required, as a cleaved fiber can be optically coupled to the fiber stub within the mechanical splice device disposed within the partially pre-assembled fiber stub connector.

The prepared cable is shown in FIG. 4. The terminal end of optical fiber drop cable 50 can be inserted in the rear end of the connector (i.e., through the jacket clamping portion 119 of the connector backbone 110) as indicated by directional arrow 91. The bare glass portion 51 and the coated portion 56 are guided through the center of clamping member between the hooked fingers until each of the rigid strength rods 58 are pushed between a pair of the facing hooked fingers 166. The cable is pushed until the buffer portion 54 of the fiber begins to bow (which occurs as the end of fiber portion meets the fiber stub in the mechanical splice element disposed in the collar body of the connector with sufficient end loading force) and the clamping member 160 is disposed in a forward position (i.e. gap 169 is disposed on the side of stops 114a closest to the front of the connector as shown in FIG. 5 A) and the buffer portion 54 of the drop cable abuts against the stops.

The mechanical splice device can then be actuated by pressing on the actuation cap 144, arrow 192 in FIG. 4) with a modest thumb or finger force while the fibers are subject to an appropriate end loading force. Alternatively, connector 100 can be mounted in a termination platform or tool, such as the 8865 AT tool, commercially available from 3M Company. In this manner, a portion of the fiber cable can be clamped by the termination tool during the actuation process.

After actuation, the bow can be released and clamping member 160 will shift backward in backbone 110 as shown in FIG. 5B such that the gap 169 between stops 114a and the edges of the cutout portion of the clamping member is now on the far side of the stops from the front of the optical fiber connector.

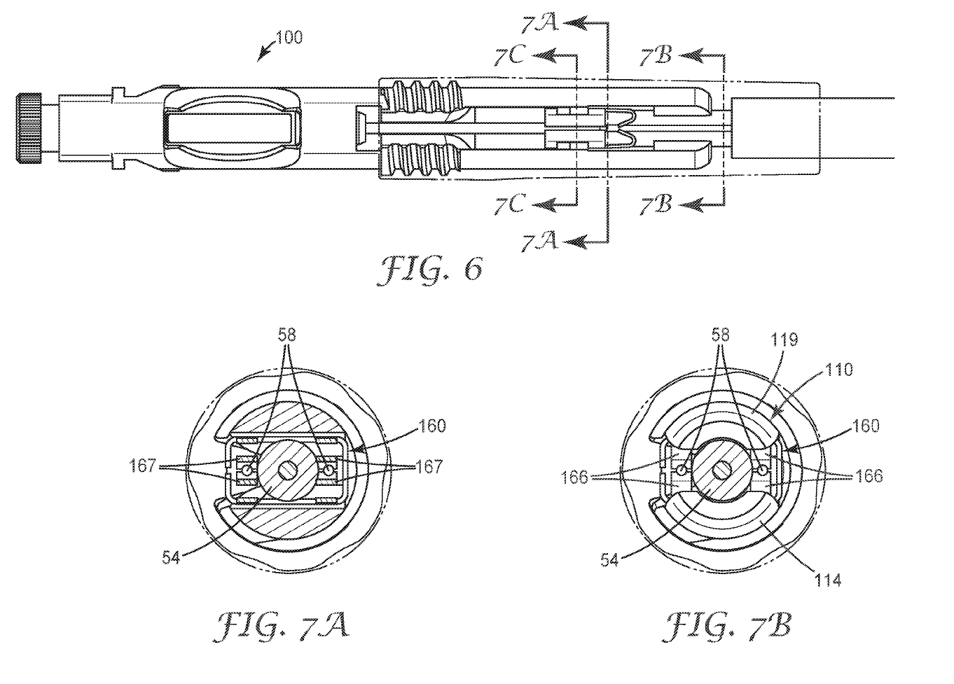

The boot 180 (which is previously threaded onto fiber cable 50) is then pushed axially toward the backbone mounting structure 115 (see FIG. 1B) and screwed onto the threads 118 on the backbone 110 to secure the boot in place. As mentioned above, the installation of the boot 180 onto the backbone 110 tightens the collet-style jacket clamping portion 119 onto the cable jacket or cable buffer to yield a fully assembled connector shown in FIG. 6.

In an alternative assembly method, clamping member 160 can be installed onto the drop cable prior to insertion of the optical fiber cable into the connector. After clamping member 160 is properly positioned, the drop cable can be inserted obliquely into the connectors, pushing the end of the fiber into the second end of the collar body and placing the clamping member between the two collet legs 114 from the side. The clamping member is pushed to its forward position as illustrated in FIG. 5A bowing the fiber. The mechanical splice device can then be actuated by pressing on the actuation cap with a modest thumb or finger force while the fibers are subject to an appropriate end loading force (i.e., the fiber is bowed). After actuation, the bow can be released and the clamping member will shift backward in backbone 110 as shown in FIG. 5B. The boot 180 is then screwed onto the threads on the backbone to secure the boot in place, tightening the collet-style jacket clamping portion 119 onto the drop cable jacket or drop cable buffer and/or compressing the pair(s) of facing hooked fingers to grab the rigid strength members, the soft polymer coating on a coated rigid strength member or the cable jacket in cables without rigid strength members.

In a cable having flexible strength members such as KEVLAR yarn or floss in the drop cable construction, the connector termination process can also include securing the flexible strength members between the backbone and the boot when the boot is attached to the threads of the backbone.

FIGS. 7A-7C are three cross-section detail views of the assembled connector 100 shown in FIG. 6.

FIG. 7A is a cross-section taken across the connector through connection point between the cantilevered portions 167 of a pair of facing hooked fingers and the rigid strength members 58. FIG. 7B is a cross-section taken through the jacket clamping portion 119 of backbone 110 looking back at the hooked fingers 166 gripping the rigid strength members 58 disposed on either side of the buffer portion 54 of the drop cable. FIG. 7C is a sectional view of the assembled connector just behind stops 114a in backbone 110 showing end position of the rigid strength members 58 near stops 114a. The geometry of clamping member 160 prevents the clamping member from being inserted into the backbone incorrectly. Referring to FIGS. 2A and 7C, the dimension, d of the body portion 161 of the clamping member 160 is less than the distance between the stops and can thus be inserted between the stops when the clamping member is installed in the backbone. The dimension D of the clamping member is larger than the distance between the stops and thus cannot pass between the stops when the clamping member is installed ensuring the proper positioning of the clamping member in the backbone.

Being able to securely grip the rigid strength members 58 can enhance the pull-out resistance of the connector as well as the thermal behavior of the connector over conventional connector designs. For optical fiber cables without rigid strength members, the cable jacket can shrink during temperature cycling tests, causing a gap to form between the end of the cable jacket and the connector. In some instances the end of the optical fiber can be pulled back in the connector which can lead to a service interruption. Similar effects can be seen in use if an optical fiber connector is exposed to temperature cycling over its service life. In contrast, less cable jacket shrinkage is seen in optical fiber cables with rigid strength members.

Additionally, the ability to clamp onto the rigid strength members in certain round cables can prevent the twisting of the cable in the connector eliminating potential torsional stresses on the optical fiber within the exemplary connector which can occur when the connector at one end of a spooled, pre-terminated cable is secured in an adapter or receptacle before unwinding the spooled cable during installation.

The optical connectors described above can be used in many conventional optical connector applications such as drop cables and/or jumpers. The optical connectors described above can also be utilized for termination (connectorization) of optical fibers for interconnection and cross connection in optical fiber networks inside a fiber distribution unit at an equipment room or a wall mount patch panel, inside pedestals, cross connect cabinets or closures or inside outlets in premises for optical fiber structured cabling applications. The optical connectors described above can also be used in termination of optical fiber in optical equipment. In addition, one or more of the optical connectors described above can be utilized in alternative applications.

As mentioned above, the optical connector of the exemplary embodiments is of compact length and is capable of straightforward field termination. Such exemplary connectors can be readily installed and utilized for FTTP and/or FTTX network installations. Clamping onto the rigid strength members increases the pull-out force required to pull the optical fiber out of the connector, providing a more robust connection to the optical fiber drop cable as compared to other conventional optical fiber connectors, especially other field mountable optical fiber connectors. Additionally, the ability to clamp onto the rigid strength members in certain round cables can prevent the twisting of the cable in the connector eliminating potential torsional stresses on the optical fiber within the exemplary connector.

Various modifications, equivalent processes, as well as numerous structures to which the present invention may be applicable will be readily apparent to those of skill in the art to which the present invention is directed upon review of the present specification.

1. An optical fiber connector for terminating a jacketed optical fiber drop cable with first and second rigid strength members, the optical fiber connector comprising:
a housing configured to mate with a receptacle;
a collar body disposed in the housing, wherein the collar body includes a ferrule mounted in a first end of the collar body and a mechanical element disposed in a portion of the collar body;
a backbone configured to retain the collar body within the housing, the backbone including a fiber guide channel between a pair of arms; and
a clamping member disposed within the fiber guide channel, the clamping member being configured to grab opposing surfaces of the first rigid strength member, and being configured to grab opposing surfaces of the second rigid strength member, to secure the first and second rigid strength members within the backbone.

2. The optical fiber connector of claim 1, wherein the clamping member comprises:
a body portion defining an aperture configured to permit passage of a portion of the optical fiber drop cable;
a first pair of integrally formed fingers proximate to a first side of the aperture, and
a second pair of integrally formed fingers proximate to a second side of the aperture;
wherein the first pair of integrally formed fingers is configured to compressively engage the first rigid strength member therebetween, and the second pair of integrally formed fingers is configured to compressively the second rigid strength member therebetween.

3. The optical fiber connector of claim 2, wherein each integrally formed finger of the first and second pairs of integrally formed fingers is bent at its distal end to form a hook portion having a cantilevered portion.

4. The optical fiber connector of claim 3, wherein the cantilevered portion of each integrally formed finger is disposed at an angle of between about 100° to about 170° relative to the body portion at a base of the integrally formed finger.

5. The optical fiber connector of claim 1, wherein the clamping member comprises a stamped and folded ductile sheet of metal.

6. The optical fiber connector of claim 1, wherein the clamping member is an injection molded plastic part.

7. The optical fiber connector of claim 1, wherein the clamping member and the backbone are configured to permit axial movement of the clamping member within the backbone.

8. The optical fiber connector of claim 2, wherein the backbone includes one or more stops within the fiber guide channel, the clamping member comprises at least one cutout in the body portion, and the at least one cutout is configured to cooperate with the one or more stops to allow the clamping member to move in an axial direction a defined amount within the backbone.

9. The optical fiber connector of claim 1, the backbone includes an access opening registered with an actuating portion of the mechanical element to permit the actuating portion to be accessed through the access opening when the collar body is retained within the housing.

10. The optical fiber connector of claim 1, wherein the optical fiber connector is a remote grip connector, and the mechanical element comprises a mechanical gripping device configured to secure a bare glass portion of the optical fiber drop cable within the optical fiber connector.

11. The optical fiber connector of claim 1, further comprising a fiber stub retained by the ferrule, and the mechanical element comprises a mechanical splicing element configured to optically interconnect a bare glass portion of the optical fiber drop cable with the fiber stub.

12. The optical fiber connector of claim 11, wherein:
the mechanical splicing element is configured to be activated by an activating cap to optically interconnect the bare glass portion of the optical fiber drop cable with the fiber stub; and
the backbone includes an access opening registered with the activating cap to permit the mechanical splicing element to be activated through the access opening when the collar body is retained within the housing.

13. The optical fiber connector of claim 2, further comprising a fiber stub disposed in the ferrule, wherein the collar body comprises a mechanical splicing element configured to optically interconnect a bare glass portion of the optical fiber drop cable with the fiber stub.

14. The optical fiber connector of claim 1, further comprising a boot engageable to a portion of the backbone, wherein a portion of the backbone comprises external threads, the boot comprises internal threads configured to mate with the external threads of the backbone, and engagement between the boot and the backbone is configured to compressively retain a jacket of the optical fiber drop cable between the pair of arms.

15. The optical fiber connector of claim 14, wherein the pair of arms includes raised inner surfaces in the form of ridges, barbs, or teeth configured to engage the jacket of the optical fiber drop cable between the pair of arms.

16. A terminated optical fiber cable comprising a jacketed optical fiber drop cable having an end thereof is terminated with an optical fiber connector according to claim 1, wherein:
the optical fiber drop cable comprises a first and second rigid strength members embodied in first and second reinforced polymer rods, respectively;
opposing surfaces of the first polymer rod are grabbed by the clamping member; and
opposing surfaces of the second polymer rod are grabbed by the clamping member.

17. A terminated optical fiber cable comprising a jacketed optical fiber drop cable having an end thereof is terminated with an optical fiber connector according to claim 2, wherein:
the optical fiber drop cable comprises a first and second rigid strength members embodied in first and second reinforced polymer rods, respectively;
the first polymer rod is compressively engaged between the first pair of integrally formed fingers; and
the second polymer rod is compressively engaged between the second pair of integrally formed fingers.

18. A method for field terminating an optical fiber drop cable having first and second rigid strength members and utilizing an optical fiber connector that comprises: a housing configured to mate with a receptacle; a collar body disposed in the housing, wherein the collar body includes a ferrule mounted in a first end of the collar body and a mechanical element disposed in a portion of the collar body; a backbone configured to retain the collar body within the housing, the backbone including a fiber guide channel between a pair of arms; and a clamping member disposed within the fiber guide channel, the clamping member comprising a body portion defining an aperture configured to permit passage of a portion of the optical fiber drop cable, a first pair of integrally formed fingers proximate to a first side of the aperture, and a second pair of integrally formed fingers proximate to a second side of the aperture; the method comprising:
inserting an end portion of the optical fiber drop cable between the pair of arms of the backbone; and
inserting the end portion of the optical fiber drop cable through the aperture of the clamping member to cause the first rigid strength member to be compressively engaged by the first pair of integrally formed fingers, and to cause the second rigid strength member to be compressively engaged by the second strength member.

19. The method of claim 18, wherein the optical fiber connector comprises a fiber stub retained by the ferrule, the mechanical element comprises a mechanical splicing element, the end portion of the optical fiber drop cable comprises a bare glass portion, and the method further comprises activating the mechanical splicing element to interconnect the bare glass portion with the fiber stub.

20. The method of claim 18, further comprising inserting a bare glass end of the optical fiber drop cable through the ferrule, and securing a bare glass portion of the optical fiber drop cable with a mechanical gripping device arranged in the collar body.

21. The method of claim 18, wherein the optical fiber connector comprises a boot engageable to a portion of the backbone, and the method further comprises threadably engaging the boot with the backbone to cause the pair of arms to compressively retain a jacket of the optical fiber drop cable therebetween.

22. The method of claim 18, further comprising:
stripping a portion of a jacket from the optical fiber drop cable;
removing a portion of a buffer layer from a terminal end of the optical fiber drop cable;
exposing a bare fiber portion of the optical fiber drop cable at the terminal end; and
cleaving a terminal end of the bare fiber portion.

23. A method for field terminating an optical fiber drop cable having first and second rigid strength members and utilizing an optical fiber connector that comprises: a housing configured to mate with a receptacle; a collar body disposed in the housing, wherein the collar body includes a ferrule mounted in a first end of the collar body and a mechanical element disposed in a portion of the collar body; a backbone configured to retain the collar body within the housing, the backbone including a fiber guide channel between a pair of arms; and a clamping member disposed within the fiber guide channel, the clamping member comprising a body portion defining an aperture configured to permit passage of a portion of the optical fiber drop cable, a first pair of integrally formed fingers proximate to a first side of the aperture, and a second pair of integrally formed fingers proximate to a second side of the aperture; the method comprising:
inserting the end portion of the optical fiber drop cable through the aperture of the clamping member to cause the first rigid strength member to be compressively engaged by the first pair of integrally formed fingers, and to cause the second rigid strength member to be compressively engaged by the second strength member;
inserting a bare glass end of the optical fiber drop cable into the collar body; and
inserting the clamping member between the pair of arms from a side of the backbone.

24. An optical fiber connector for terminating a jacketed optical fiber drop cable with first and second rigid strength members, the optical fiber connector comprising:
a housing configured to mate with a receptacle;
a collar body disposed in the housing, wherein the collar body includes a ferrule mounted in a first end of the collar body and a mechanical element disposed in a portion of the collar body;
a backbone configured to retain the collar body within the housing, the backbone including a fiber guide channel between a pair of arms; and
a clamping member disposed within the fiber guide channel, the clamping member comprising: (i) a body portion defining an aperture configured to permit passage of a portion of the optical fiber drop cable; (ii) a first pair of integrally formed fingers proximate to a first side of the aperture, and (iii) a second pair of integrally formed fingers proximate to a second side of the aperture; wherein the first pair of integrally formed fingers is configured to compressively engage the first rigid strength member therebetween, and the second pair of integrally formed fingers is configured to compressively engage the second rigid strength member therebetween;
wherein the backbone includes an access opening registered with an actuating portion of the mechanical element to permit the actuating portion to be accessed through the access opening when the collar body is retained within the housing.

25. The optical fiber connector of claim 24, wherein the optical fiber connector is a remote grip connector, and the mechanical element comprises a mechanical gripping device configured to secure a bare glass portion of the optical fiber drop cable within the optical fiber connector.

26. The optical fiber connector of claim 24, further comprising a fiber stub retained by the ferrule, and the mechanical element comprises a mechanical splicing element configured to optically interconnect a bare glass portion of the optical fiber drop cable with the fiber stub.

27. The optical fiber connector of claim 24, wherein the clamping member comprises a stamped and folded ductile sheet of metal.

28. The optical fiber connector of claim 24, further comprising a boot engageable to a portion of the backbone, wherein a portion of the backbone comprises external threads, the boot comprises internal threads configured to mate with the external threads of the backbone, and engagement between the boot and the backbone is configured to compressively retain a jacket of the optical fiber drop cable between the pair of arms.
